(19) United States
(12) Patent Application Publication
(10) Pub. No.: US 2025/0307672 A1
(43) Pub. Date: Oct. 2, 2025

(54) COMBINATORIAL REASONING SYSTEMS AND METHODS

(71) Applicant: Icosa Computing Inc., New York, NY (US)

(72) Inventors: Mert Esencan, New York, NY (US); Can Unlu, Sunnyvale, CA (US); Tarun Advaith Kumar, Pleasanton, CA (US); Alan Ho, Los Angeles, CA (US)

(21) Appl. No.: 19/092,879

(22) Filed: Mar. 27, 2025

Related U.S. Application Data
(60) Provisional application No. 63/571,220, filed on Mar. 28, 2024.
(60) Provisional application No. 63/571,229, filed on Mar. 28, 2024.
(60) Provisional application No. 63/571,233, filed on Mar. 28, 2024.

(51) Int. Cl. G06N 5/04; G06N 7/01

(52) U.S. Cl. CPC G06N 5/04; G06N 7/01

(57) ABSTRACT

Techniques of reasoning generative intelligence that include: receiving a query; determining a set of system instructions corresponding to the query; generating, based on the query and the set of system instructions, an initial prompt comprising a set of reason queries; submitting the initial prompt to a first large language model (LLM) to obtain a set of sample reasons corresponding to the set of reason queries; determining, based on application of optimization to the set of sample reasons, a reduced set of reasons; generating, based on the reduced set of reasons, an execution prompt; submitting the execution prompt to a second LLM to obtain a query response; and employing the query response in response to the query.

### RELATED APPLICATIONS

This application claims benefit of and priority to U.S. Provisional Patent Application No. 63/571,220 titled “IMPROVING LARGE LANGUAGE MODELS WITH COMBINATORIAL OPTIMIZATION” and filed Mar. 28, 2024, U.S. Provisional Patent Application No. 63/571,229 titled “COMBINATORIAL REASONING SYSTEMS AND METHODS” and filed Mar. 28, 2024, and U.S. Provisional Patent Application No. 63/571,233 titled “COMBINATORIAL REASONING OPTIMIZATION SYSTEMS AND METHODS” and filed Mar. 28, 2024, which are each hereby incorporated by reference in its entirety.

### FIELD

Embodiments relate generally to generative intelligence and, more particularly, to the integration of combinatorial reasoning (CR) in generative intelligence systems.

### BACKGROUND

Generative intelligence refers to artificial intelligence (AI) systems capable of autonomously generating content, solutions, or insights in response to user queries, such as those submitted by users. These systems often leverage probabilistic models, statistical learning, and pattern recognition to synthesize information and produce human-like responses.

One of the most widely used forms of generative intelligence is large language models (LLMs), which employ deep neural networks to process and generate text based on contextual input. LLMs are typically trained on vast datasets, enabling them to recognize patterns, infer relationships, and generate coherent and contextually relevant outputs. These models have demonstrated proficiency in tasks such as text summarization, translation, question answering, and code generation. Beyond LLMs, generative intelligence also extends to multimodal models, which process and synthesize information across different data types, including images, audio, and structured data. These systems are often applied in conversational AI, decision support, autonomous reasoning, and scientific discovery.

### SUMMARY

As generative intelligence continues to evolve, researchers and engineers seek to integrate optimization strategies and decision-making frameworks to enhance reasoning depth, response accuracy, and computational efficiency. Generative intelligence, particularly large language models (LLMs), has advanced significantly in natural language processing, content generation, and decision support systems. However, existing LLMs face inherent challenges in reasoning, particularly when generating responses that require complex logical deductions, strategic planning, or multi-step problem-solving.

A fundamental aspect of generative intelligence is prompt engineering, which involves crafting structured inputs to guide AI-generated outputs. Techniques such as few-shot learning and in-context learning can enable LLMs to adapt to specific tasks without explicit retraining. Additionally, methods like retrieval-augmented generation (RAG) and chain-of-thought (CoT) prompting can enhance reasoning by incorporating external knowledge or predefined logical structures. While these techniques improve response accuracy, they typically rely on static reasoning structures that may not dynamically adapt to the specific context of a given query. These methods often lack effective optimization mechanisms for selecting reasoning steps, leading to inconsistent or suboptimal outputs

Provided are combinatorial reasoning (CR) techniques that can improve generative intelligence performance by, for example, integrating discrete optimization processes that dynamically determine and employ relevant reasoning paths for a given query. Certain embodiments enhance generative intelligence systems by leveraging cost function-based optimization techniques, such as Quadratic Unconstrained Binary Optimization (QUBO) and higher order models (e.g., higher than quadratic correlations), such as Ising models, to define and solve reasoning selection as an optimization problem. This can enable the automated identification and selection of optimal reasoning steps, leading to technological improvements in response accuracy, contextual adaptation, and computational efficiency. Such a system can enhance generative intelligence capabilities by improving response quality and reducing dependence on extensive model pre-training and manually curated prompt engineering.

In some embodiments, in response to receiving a query, a corresponding set of system instructions is identified, and an initial prompt (e.g., including a set of individual reason queries) is generated. The initial prompt is submitted to a large language model (LLM), which generates a set of sample reasons, with each reason corresponding to an individual query. The sample set is analyzed and processed to eliminate redundant, conflicting, or semantically overlapping reasons, resulting in a reduced reason set that includes a set of distinct and unique reasons. Subsequently, an execution prompt is generated, incorporating the reduced reason set and the original query or a reformulated version thereof. The execution prompt is submitted to an LLM (which may be the same as or different from the initial LLM), and a query response is generated. In some embodiments, the query response is provided to a user or otherwise employed in an automated system. For example, the query response may be used to automatically configure parameters of a control system for mechanical, computational, or decision-making applications or to generate structured output for downstream processing.

Although certain embodiments are described in the context of improving reasoning capabilities in LLMs for purposes of explanation, embodiments may be applied to any suitable generative intelligence system, including but not limited to multimodal AI models, decision-support systems, autonomous agents, and knowledge retrieval frameworks. Additionally, while certain embodiments describe query processing and reasoning selection for natural language tasks, combinatorial reasoning techniques may be employed to optimize complex decision-making, data synthesis, structured problem-solving, or other computational processes across a broad range of domains. Embodiments can be executed or otherwise employed on various suitable devices, such as combinatorial optimization hardware, which may include, for example, quantum computers such as quantum annealers or gate-based hardware systems, and Ising machines such as coherent Ising machines. Embodiment can be employed in various suitable combinatorial optimization algorithms, such as conventional discrete variable solvers such as simulated annealing and parallel tempering, and quantum-inspired solvers such as digital annealing. Moreover, embodiments may be employed using described combinatorial reasoning-based optimization (“combinatorial optimization”) or other forms of optimization.

Provided in some embodiments is a generative intelligence system including a reasoning engine adapted to: receive a query; determine a set of system instructions corresponding to the query; generate, based on the query and the set of system instructions, an initial prompt including a set of reason queries; submit the initial prompt to a first large language model (LLM) to obtain a set of sample reasons corresponding to the set of reason queries; determine, based on application of optimization to the set of sample reasons, a reduced set of reasons; generate, based on the reduced set of reasons, an execution prompt; submit the execution prompt to a second LLM to obtain a query response; and employ the query response in response to the query.

In some embodiments, determining the reduced set of reasons includes applying of a combinatorial or continuous optimization framework that employs a quadratic or higher order cost function. In certain embodiments, determining the reduced set of reasons includes applying Quadratic Unconstrained Binary Optimization (QUBO). In some embodiments, determining the reduced set of reasons includes applying a quadratic or higher order Ising model. In certain embodiments, determining the reduced set of reasons includes utilizing more than one low-energy solutions in the form of a solution distribution from an optimizer. In some embodiments, the submitting of the initial prompt includes submission of individual reason queries of the set of reason queries to the LLM; where the set of sample reasons includes individual reasons generated responsive to the individual reason queries submitted to the LLM, where determining a reduced set of reasons includes: vectorizing the individual reasons to generate a reason vector set including reason vectors for the individual reasons; determining, based on a comparison of the reason vectors: a set of similar individual reasons that includes two or more reasons of the set of sample reasons that are similar; and a set of unique individual reasons that includes one or more of the reasons of the set of sample reasons that are distinct from other reasons of the set of sample reasons; generating, based on the set of similar individual reasons, a reduced individual reason that corresponds to the two or more reasons of the set of sample reasons that are similar; generating, based on the set of unique individual reasons and the reduced individual reason, a set of distinct reasons, the set of distinct reasons including: a first subset of distinct reasons corresponding to the set of unique individual reasons; and a second subset of the distinct reasons corresponding to the reduced individual reason; and applying a cost function to the set of distinct reasons to determine the reduced set of reasons. In certain embodiments, the set of system instructions defines a number of reason queries to be included in the set of reason queries and a temperature parameter adapted to control a level of response diversity for the set of reason queries. In some embodiments, the set of reason queries includes a given number (N) of input prompts, where N is greater than 1, where the set of sample reasons includes reasons generated by the first LLM in response to the respective N input prompts, where the reduced set of reasons includes distinct reasons generated based on the reasons. In certain embodiments, the execution prompt includes: an execution set of reasons that correspond to the reduced set of reasons; and an execution query that corresponds to the query. In some embodiments, the query is submitted by a user and employing the query response includes providing the query response to the user in response to the query, or where employing the query response includes controlling a system based on the query response. In certain embodiments, the reasoning engine adapted to dynamically select parameters for the optimization. In some embodiments, included is combinatorial optimization hardware, where some or all of the operations of the reasoning engine is executed on the combinatorial optimization hardware.

Provided in some embodiments is a method of reasoning generative intelligence including: receiving a query; determining a set of system instructions corresponding to the query; generating, based on the query and the set of system instructions, an initial prompt including a set of reason queries; submitting the initial prompt to a first large language model (LLM) to obtain a set of sample reasons corresponding to the set of reason queries; determining, based on application of optimization to the set of sample reasons, a reduced set of reasons; generating, based on the reduced set of reasons, an execution prompt; submitting the execution prompt to a second LLM to obtain a query response; and employing the query response in response to the query.

In some embodiments, determining the reduced set of reasons includes applying of a combinatorial or continuous optimization framework that employs a quadratic or higher order cost function. In certain embodiments, determining the reduced set of reasons includes applying Quadratic Unconstrained Binary Optimization (QUBO). In some embodiments, determining the reduced set of reasons includes applying a quadratic or higher order Ising model. In certain embodiments, determining the reduced set of reasons includes utilizing more than one low-energy solutions in the form of a solution distribution from an optimizer. In some embodiments, the submitting of the initial prompt includes submission of individual reason queries of the set of reason queries to the LLM; where the set of sample reasons includes individual reasons generated responsive to the individual reason queries submitted to the LLM, where determining a reduced set of reasons includes: vectorizing the individual reasons to generate a reason vector set including reason vectors for the individual reasons; determining, based on a comparison of the reason vectors: a set of similar individual reasons that includes two or more reasons of the set of sample reasons that are similar; and a set of unique individual reasons that includes one or more of the reasons of the set of sample reasons that are distinct from other reasons of the set of sample reasons; generating, based on the set of similar individual reasons, a reduced individual reason that corresponds to the two or more reasons of the set of sample reasons that are similar; generating, based on the set of unique individual reasons and the reduced individual reason, a set of distinct reasons, the set of distinct reasons including: a first subset of distinct reasons corresponding to the set of unique individual reasons; and a second subset of the distinct reasons corresponding to the reduced individual reason; and applying a cost function to the set of distinct reasons to determine the reduced set of reasons. In certain embodiments, the set of system instructions defines a number of reason queries to be included in the set of reason queries and a temperature parameter adapted to control a level of response diversity for the set of reason queries. In some embodiments, the set of reason queries includes a given number (N) of input prompts, where N is greater than 1, where the set of sample reasons includes reasons generated by the first LLM in response to the respective N input prompts, where the reduced set of reasons includes distinct reasons generated based on the reasons. In certain embodiments, the execution prompt includes: an execution set of reasons that correspond to the reduced set of reasons; and an execution query that corresponds to the query. In some embodiments, the query is submitted by a user and employing the query response includes providing the query response to the user in response to the query, or where employing the query response includes controlling a system based on the query response. In certain embodiments, the reasoning engine adapted to dynamically select parameters for the optimization.

Provided in some embodiments is non-transitory computer-readable storage medium including program instructions stored thereon that are executable by a processor to cause the following operations for reasoning generative intelligence: receiving a query; determining a set of system instructions corresponding to the query; generating, based on the query and the set of system instructions, an initial prompt including a set of reason queries; submitting the initial prompt to a first large language model (LLM) to obtain a set of sample reasons corresponding to the set of reason queries; determining, based on application of optimization to the set of sample reasons, a reduced set of reasons; generating, based on the reduced set of reasons, an execution prompt; submitting the execution prompt to a second LLM to obtain a query response; and employing the query response in response to the query.

In some embodiments, determining the reduced set of reasons includes applying of a combinatorial or continuous optimization framework that employs a quadratic or higher order cost function. In certain embodiments, determining the reduced set of reasons includes applying Quadratic Unconstrained Binary Optimization (QUBO). In some embodiments, determining the reduced set of reasons includes applying a quadratic or higher order Ising model. In certain embodiments, determining the reduced set of reasons includes utilizing more than one low-energy solutions in the form of a solution distribution from an optimizer. In some embodiments, the submitting of the initial prompt includes submission of individual reason queries of the set of reason queries to the LLM; where the set of sample reasons includes individual reasons generated responsive to the individual reason queries submitted to the LLM, where determining a reduced set of reasons includes: vectorizing the individual reasons to generate a reason vector set including reason vectors for the individual reasons; determining, based on a comparison of the reason vectors: a set of similar individual reasons that includes two or more reasons of the set of sample reasons that are similar; and a set of unique individual reasons that includes one or more of the reasons of the set of sample reasons that are distinct from other reasons of the set of sample reasons; generating, based on the set of similar individual reasons, a reduced individual reason that corresponds to the two or more reasons of the set of sample reasons that are similar; generating, based on the set of unique individual reasons and the reduced individual reason, a set of distinct reasons, the set of distinct reasons including: a first subset of distinct reasons corresponding to the set of unique individual reasons; and a second subset of the distinct reasons corresponding to the reduced individual reason; and applying a cost function to the set of distinct reasons to determine the reduced set of reasons. In certain embodiments, the set of system instructions defines a number of reason queries to be included in the set of reason queries and a temperature parameter adapted to control a level of response diversity for the set of reason queries. In some embodiments, the set of reason queries includes a given number (N) of input prompts, where N is greater than 1, where the set of sample reasons includes reasons generated by the first LLM in response to the respective N input prompts, where the reduced set of reasons includes distinct reasons generated based on the reasons. In certain embodiments, the execution prompt includes: an execution set of reasons that correspond to the reduced set of reasons; and an execution query that corresponds to the query. In some embodiments, the query is submitted by a user and employing the query response includes providing the query response to the user in response to the query, or where employing the query response includes controlling a system based on the query response. In certain embodiments, the reasoning engine adapted to dynamically select parameter for the optimization.

### BRIEF DESCRIPTION OF THE DRAWINGS

FIG. 1 is a diagram that illustrates a generative intelligence environment in accordance with one or more embodiments.

FIG. 2 is a diagram that illustrates aspects of a combinatorial reasoning engine in accordance with one or more embodiments.

FIGS. 3 and 4 are diagrams that illustrate example operational aspects of a combinatorial reasoning engine in accordance with one or more embodiments.

FIG. 5 is a flowchart that illustrates a method of implementing combinatorial reasoning based generative intelligence in accordance with one or more embodiments.

FIG. 6 is a diagram that illustrates an example computer system in accordance with one or more embodiments.

While this disclosure is susceptible to various modifications and alternative forms, specific embodiments are shown and described. The drawings may not be to scale. It should be understood that the drawings and the detailed description are not intended to limit the disclosure to a particular form disclosed, but rather to illustrate modifications, equivalents, and alternatives falling within the spirit and scope of the present disclosure as defined by the claims.

### DETAILED DESCRIPTION

Provided are combinatorial reasoning (CR) techniques that can improve generative intelligence performance by, for example, integrating discrete optimization processes that dynamically determine and employ relevant reasoning paths for a given query. Certain embodiments enhance generative intelligence systems by leveraging cost function-based optimization techniques, such as Quadratic Unconstrained Binary Optimization (QUBO) and higher order models (e.g., higher than quadratic correlations), such as Ising models, to define and solve reasoning selection as an optimization problem. This can enable the automated identification and selection of optimal reasoning steps, leading to technological improvements in response accuracy, contextual adaptation, and computational efficiency. Such a system can enhance generative intelligence capabilities by improving response quality and reducing dependence on extensive model pre-training and manually curated prompt engineering.

In some embodiments, in response to receiving a query, a corresponding set of system instructions is identified, and an initial prompt (e.g., including a set of individual reason queries) is generated. The initial prompt is submitted to a large language model (LLM), which generates a set of sample reasons, with each reason corresponding to an individual query. The sample set is analyzed and processed to eliminate redundant, conflicting, or semantically overlapping reasons, resulting in a reduced reason set that includes a set of distinct and unique reasons. Subsequently, an execution prompt is generated, incorporating the reduced reason set and the original query or a reformulated version thereof. The execution prompt is submitted to an LLM (which may be the same as or different from the initial LLM), and a query response is generated. In some embodiments, the query response is provided to a user or otherwise employed in an automated system. For example, the query response may be used to automatically configure parameters of a control system for mechanical, computational, or decision-making applications or to generate structured output for downstream processing.

Although certain embodiments are described in the context of improving reasoning capabilities in LLMs for purposes of explanation, embodiments may be applied to any suitable generative intelligence system, including but not limited to multimodal AI models, decision-support systems, autonomous agents, and knowledge retrieval frameworks. Additionally, while certain embodiments describe query processing and reasoning selection for natural language tasks, combinatorial reasoning techniques may be employed to optimize complex decision-making, data synthesis, structured problem-solving, or other computational processes across a broad range of domains. Embodiments can be executed or otherwise employed on various suitable devices, such as combinatorial optimization hardware, which may include, for example, quantum computers such as quantum annealers or gate-based hardware systems, and Ising machines such as coherent Ising machines. Embodiment can be employed in various suitable combinatorial optimization algorithms, such as conventional discrete variable solvers such as simulated annealing and parallel tempering, and quantum-inspired solvers such as digital annealing. Moreover, embodiments may be employed using described combinatorial reasoning-based optimization (“combinatorial optimization”) or other forms of optimization.

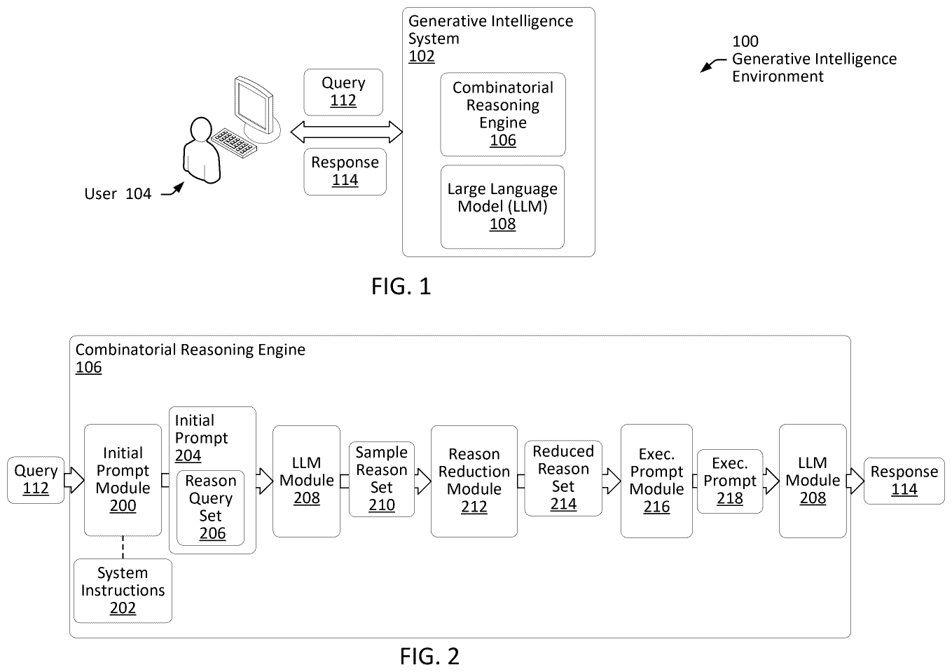

FIG. 1 is a diagram that illustrates a generative intelligence environment 100 in accordance with one or more embodiments. In the illustrated embodiment, generative intelligence environment 100 includes a generative intelligence system 102 and a user 104. Generative intelligence system 102 includes a combinatorial reasoning engine 106 and a large language model (LLM) 108. In operation, user 104 may submit a query 112 to generative intelligence system 102, which processes query 112 (e.g., through combinatorial reasoning engine 106 and LLM 108) to generate a corresponding response 114. As described, the combinatorial reasoning engine 106 may employ combinatorial reasoning-based optimization, also referred to as “combinatorial optimization”. This may include cost function-based optimization techniques, such as quadratic (e.g., Quadratic Unconstrained Binary Optimization (QUBO)) and higher order models (e.g., Ising models), to determine an optimal reasoning path.

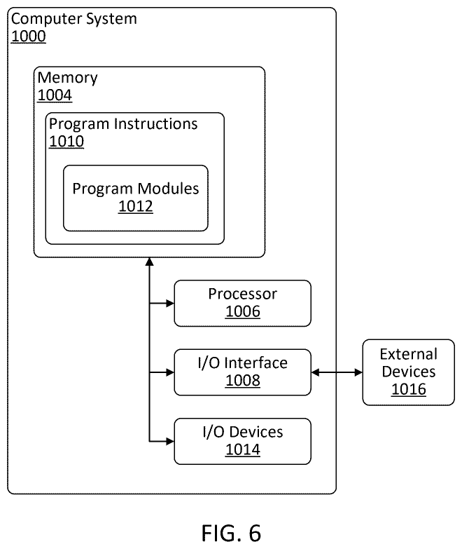

In some embodiments, generative intelligence system 102 is operable to process query 112 using combinatorial reasoning techniques. For example, generative intelligence system 102 may receive query 112, determine an optimal reasoning path using combinatorial reasoning engine 106, interact with LLM 108 to generate a response, and provide response 114 to user 104. Such a technique may improve the reasoning capabilities and overall performance of LLMs. In some embodiments, generative intelligence system 102 may be implemented as a cloud-based AI service, an on-device AI model, or a hybrid system that integrates local and remote AI processing resources. In some embodiments, generative intelligence system 102 includes a computer system that is the same or similar to the of computer system 1000 described with regard to at least FIG. 6.

In some embodiments, user 104 is an entity (e.g., a human user, an automated system, or another AI model) that submits query 112 to generative intelligence system 102. In some embodiments, user 104 interacts with generative intelligence system 102 via a user interface, an API, or an embedded AI assistant. Queries may range from natural language questions to structured commands for decision-making, automation, content generation, or the like. For example, user 104 may be a person or a software agent operating within a networked application, such as a financial analytics tool, customer support chatbot, or autonomous control system.

In some embodiments, query 112 is an input received by generative intelligence system 102 that prompts processing by combinatorial reasoning engine 106. In some embodiments, query 112 may be a text-based prompt, a multimodal input, or a structured request specifying constraints or objectives. For example, query 112 may include a task description, a policy rule, a domain-specific instruction, or a data-driven objective such as “Explain the key factors influencing stock market volatility,” “Identify regulatory risks in this contract provision,” or “Determine optimal inventory strategy for seasonal demand fluctuations.”

In some embodiments, combinatorial reasoning engine 106 is operable to analyze query 112, generate an optimized reasoning structure and refined reasoning paths that are employed by prompts provided to LLM 108. This may include implementation of combinatorial or continuous optimization. In some embodiments, combinatorial reasoning engine 106 applies cost function-based optimization techniques, such as quadratic (e.g., Quadratic Unconstrained Binary Optimization (QUBO)) and higher order models (e.g., Ising models), to determine an optimal reasoning path. The optimization may employ discrete variables or non-discrete, continuous variables. The engine may also employ tunable parameters (e.g., including hyperparameters, such as “relative importance of frequency to consistency”), additional heuristic techniques or machine learning algorithms to refine reasoning selection dynamically. For example, combinatorial reasoning engine 106 may be a set of software modules that are operable to dynamically select (or “tune”) parameters, such as hyperparameters and temperature, based on characteristics of the query (e.g., using different sets of parameters for a finance question vs a health question), use semantic similarity scoring to filter redundant responses, apply QUBO-based selection to identify a diverse subset of supporting reasons, and construct reasoning sequences that improve LLM response coherence. In such an embodiment, parameter tuning (or “selection”) is based on application of machine learning modules to user data, which can provide for dynamic tuning of the system and its performance.

In some embodiments, LLM 108 is a large language model that is included in or accessed by components of combinatorial reasoning engine 106. In some embodiments, LLM 108 is a single model or a collection of models specialized for different reasoning tasks. System 102 may dynamically select among multiple LLMs based on query complexity, computational constraints, or task requirements. For example, a LLM module may route initial reasoning queries to a general-purpose model and execution prompts to a domain-specialized model, or switch between models based on latency, token limit, or precision constraints.

Response 114 is an output generated by generative intelligence system 102 based on processing of query 112. In some embodiments, response 114 is returned to user 104 as a natural language output, an action command, or structured data that can be processed by an external system. The response may be used for decision-making, automation, or interactive AI-driven tasks. For example, response 114 may include a textual explanation of market factors and conditions, structured risk scores for regulatory compliance, system configuration parameters, or predictive insights derived from input data.

FIG. 2 is a diagram that illustrates aspects of combinatorial reasoning engine 106 in accordance with one or more embodiments. In some embodiments, combinatorial reasoning engine 106 receives query 112, processes it through a structured pipeline that generates and employs reasoning prompts, filters responses using combinatorial optimization, and constructs an execution prompt that is submitted to LLM 108, which generates a corresponding query response 114. In the illustrated embodiment, combinatorial reasoning engine 106 includes an initial prompt module 200, a LLM module 208, a reason reduction module 212, and an execution prompt module 216.

In some embodiments, in response to receiving a query 112, initial prompt module 200 identifies a corresponding set of system instructions 202 and generates an initial prompt 204, which includes a reason query set 206 (a “set of reason queries”) (e.g., a set of individual reason queries, which may be identical or different queries) and additional parameters (e.g., LLM temperature). Initial prompt 204 is provided to LLM module 208, which submits a corresponding prompt (e.g., the set of identical, individual reason queries accompanied by LLM temperature) to LLM 108, where LLM 108 generates and returns a set of reasons (e.g., including a set of individual reasons provided in response to each of the individual reason queries). LLM module 208 provides a corresponding sample reason set (a “set of sample reasons”) 210 (e.g., the set of individual reasons provided by the LLM 108) to reason reduction module 212, which assesses and process sample reason set 210 to eliminate redundant (or “similar”) reasons and generate a corresponding reduced reason set 214 that includes a set of distinct (or “unique”) reasons from sample reason set 210 (e.g., a reason set that includes one or more single reasons in place of multiple, similar reasons). Reason reduction module 212 provides reduced reason set (a “reduced set of reasons”) 214 to execution prompt module 216, which assesses and processes reduced reason set 214 to generate a corresponding execution prompt 218 (e.g., one or more prompts that include an optimized set of reasons, which may be the same or similar to those of reduced reason set 214 or a version of the reason set 214 further reduced by optimization, a query that is the same or similar to query 112, and other prompt items). Execution prompt 218 is provided to LLM module 208, which submits a corresponding prompt (e.g., a concatenation of the set of reasons and the query, along with formatting instructions) to LLM 108, where LLM 108 generates and returns a corresponding query response 114.

### Generating Initial Prompt and Sample Reason Set

In some embodiments, initial prompt module 200 is operable to generate initial prompt 204 in response to query 112. Initial prompt module 200 may, for example, identify a corresponding set of system instructions 202, which define parameters for processing query 112, and, based on system instructions 202, construct an initial prompt 204, which includes a reason query set 206 (e.g., a set of identical individual queries for reasons) and additional query parameters, such as LLM temperature settings or context-specific instructions.

In some embodiments, system instructions 202 define the following: the number of reason queries (N) (e.g., to be submitted in parallel), a temperature setting (e.g., for controlling randomness in the LLM's responses), formatting constraints for generated outputs (e.g., expected output format, structure, or length), or the like. For example, system instructions 202 may include the following: N=5 (meaning five identical queries should be submitted in parallel to ensure response variability); Temperature=0.7 (instructing the LLM to allow for a moderate level of response diversity while maintaining coherence); Response Length Limit=100 tokens (constraining the output size to ensure concise reasoning); Instruction to Prioritize Causal Relationships (requiring that responses emphasize cause-and-effect reasoning rather than general descriptions); Domain-Specific Constraints (such as requiring responses to include citations to specific datasets when processing scientific queries); and Prohibition on Unverified Information (directing the LLM to filter out speculative or hallucinated reasoning). For instance, if query 112 is: “Explain the key factors influencing stock market volatility,” then system instructions 202 might specify: N=10 (to ensure multiple perspectives); Temperature=0.5 (to balance creativity and determinism); Output format=bullet points (to ensure structured reasoning); and Required data sources=historical S&P 500 trends (to ensure responses reference empirical data). Such instructions may ensure that LLM 108 generates high-quality, structured responses while maintaining diversity in reasoning paths.

In some embodiments, reason query set 206 includes a number (N) of identical queries that are to be submitted in parallel to LLM 108. Continuing with the above example, where N=10, the reason query set 206 may consist of ten identical instances of: “Explain the key factors influencing stock market volatility.” In such an embodiment, LLM module 208 may, in turn, submit the ten identical queries in parallel to LLM 108, where each instance is expected to yield a potentially distinct response due to the applied temperature setting.

In some embodiments, initial prompt module 200 constructs initial prompt 204 by incorporating reason query set 206 and additional query parameters (e.g., temperature settings, response format instructions). Since system 102 submits N identical queries in parallel, the initial prompt must be structured to ensure consistency while allowing for reasoning diversity. Below is an example of what initial prompt 204 might contain for the stock market volatility case:

### System Instructions:

“The model should provide clear and structured responses. Each response must contain a reasoning step related to stock market volatility. Responses should be concise (max 100 tokens) and formatted as standalone statements. Use historical data trends where applicable. Avoid speculative claims or unverifiable information.”

### Reason Query Set (N Identical Queries to be Submitted in Parallel):

1. “Explain a key factor influencing stock market volatility.”
2. “Explain a key factor influencing stock market volatility.”
3. “Explain a key factor influencing stock market volatility.”
4. “Explain a key factor influencing stock market volatility.”
5. “Explain a key factor influencing stock market volatility.”
6. “Explain a key factor influencing stock market volatility.”
7. “Explain a key factor influencing stock market volatility.”
8. “Explain a key factor influencing stock market volatility.”
9. “Explain a key factor influencing stock market volatility.”
10. “Explain a key factor influencing stock market volatility.”

### Additional Query Parameters:

Temperature Setting: 0.7 (to allow moderate variation in reasoning paths).
Output Length Limit: 100 tokens.
Formatting: Bullet-point style responses with a singular reasoning step per response.

This initial prompt 204 may ensure that LLM 108 generates a diverse set of responses by leveraging temperature-based variability while maintaining consistency in query formulation. As described, the responses may be collected into sample reason set 210, where they undergo reason reduction and QUBO-based optimization before constructing the final execution prompt 218. This structured process allows system 102 to gather a broad set of reasoning candidates while preserving semantic consistency, laying the groundwork for effective optimization in subsequent stages.

In some embodiments, sample reason set 210 includes responses to the reason query set 206. Continuing with the above example, where the reason query set 206 consists of ten identical instances of: “Explain the key factors influencing stock market volatility” and LLM module 208 submits the ten identical queries in parallel to LLM 108, the sample reason set 210 may include the ten corresponding responses-one for each of the ten instances submitted, which may each include a respective response reason set that includes one or more reasons. For example, where one reasoning query is provided to the LLM, there may be ten reasons generated. Where ten reasoning queries provided to the LLM, there may be 100 reasons generated. In some embodiments, the number of reasons generated for a query is variable. Since LLM 108 uses probabilistic token selection, each instance of the query may yield a slightly different response, such as:
1. “Investor sentiment brings market speculation, leading to price swings.”
2. “Interest rate changes affect stock valuations and investor confidence.”
3. “Earnings reports introduce volatility by setting investor expectations.”
4. “Algorithmic trading amplifies small market movements.”
5. “Geopolitical events introduce uncertainty, increasing volatility.”
6. “Supply chain disruptions impact company revenues and stock performance.”
7. “Federal Reserve policy decisions create uncertainty in bond-equity markets.”
8. “Short-selling can increase volatility by forcing rapid price adjustments.”
9. “Stock buybacks reduce outstanding shares, affecting price movements.”
100. “Economic indicators such as unemployment rates influence investor confidence.”

In such an embodiment, LLM module 208 may assemble the responses (or “reasons”), such as the one hundred provided above, into a sample reason set 210 and provide the sample reason set 210 to reason reduction module 212 for further processing and optimization.

### Generation of Reduced Reason Set

In some embodiments, reason reduction module 212 is operable to process sample reason set 210 to generate a reduced reason set 214. This may include consolidating similar reasons to eliminate redundant or semantically similar reasons and generate a subset of distinct, representative reasons. As described, the process may apply combinatorial optimization techniques to balance diversity, coherence, and reasoning accuracy in the set of reasons that are used for generating an execution prompt 218 and, in turn, the corresponding response 114 to query 112. In some embodiments, the reason reduction process involves three steps: sampling of reasons; QUBO mapping; and combinatorial optimization solving, which are described in more detail herein.

### Sampling of Reasons

In some embodiments, given a query 112, system 102 generates N identical input prompts and submits them to LLM 108 at a predefined temperature setting. The temperature parameter controls the level of variation in the responses: a higher temperature (e.g., 1.0) encourages more diverse and exploratory responses; whereas a lower temperature (e.g., 0.0) forces deterministic responses, meaning identical outputs for identical queries. Each response from LLM 108 includes a set of reasons, which are text-based strings representing concise justifications or explanations related to the query. Some of these reasons may be redundant (e.g., they convey the same idea with slightly different wording), conflicting (e.g., they provide opposing viewpoints), or complementary (e.g., they add distinct but relevant insights). To efficiently process these responses, each reason may be first embedded into a high-dimensional space using a pretrained sentence transformer model (e.g., all-mpnet-base-v2, from HuggingFace). This embedding may enable: semantic similarity detection (e.g., identifying reasons that overlap in meaning), clustering of related reasons (e.g., grouping reasons that convey the same concept), or filtering of redundant responses (e.g., ensuring that the final set includes only distinct reasons).

In some embodiments, mathematical definitions of sampled reasons are defined and employed as follows:

Let R be the total set of sampled reasons from LLM 108. Define:
rₜₒₜₐₗ: The complete set of all sampled reasons across all responses.
r_{distinct}: The subset of unique, semantically distinct reasons after filtering.
nᵢ. The number of times a particular reason rᵢ appears in the N generated responses.
nᵢⱼ: The number of times two reasons rᵢ and rⱼ appear together in the same response.
   These counts may allow system 102 to determine reason frequency, co-occurrence patterns, and semantic redundancy.

### Step 1: Generating Sample Reasons

In some embodiments, after submitting N identical queries, system 102 receives N responses, each containing a set of reasons. These reasons may be strings extracted from the LLM's output and may vary depending on the temperature setting and stochastic nature of the model. For example, if query 112 is: “Explain the key factors influencing stock market volatility,” and N=10, system 102 may generate the following sample reason set 210 (e.g., the same as the example provided above), where each of these responses is a string representation of an LLM-generated reasoning step for the query:
1. “Investor sentiment brings market speculation, leading to price swings.”
2. “Interest rate changes affect stock valuations and investor confidence.”
3. “Earnings reports introduce volatility by setting investor expectations.”
4. “Algorithmic trading amplifies small market movements.”
5. “Geopolitical events introduce uncertainty, increasing volatility.”
6. “Supply chain disruptions impact company revenues and stock performance.”
7. “Federal Reserve policy decisions create uncertainty in bond-equity markets.”
8. “Short-selling can increase volatility by forcing rapid price adjustments.”
9. “Stock buybacks reduce outstanding shares, affecting price movements.”
100. “Economic indicators such as unemployment rates influence investor confidence.”

### Step 2: Embedding and Similarity Analysis

In some embodiments, once the sample reason set 210 is collected, each reason string is converted into a vector representation using a pretrained sentence embedding model. For example, each reason rᵢ is assigned a vector vᵢ in a 768-dimensional space. Using these vector embeddings, system 102 may compute similarity between each pairing of the ten reasons, to determine how closely each reason is related to each of the other reasons. For example, a similarity between two reasons (rᵢ and rⱼ having respective computed vectors vᵢ and vⱼ) may be computed using cosine similarity, as follows:

$$Similarity ( {r}_{i} , {r}_{j} ) = \frac{{v}_{i} \cdot {v}_{j}}{‖ {v}_{i} ‖ ‖ {v}_{j} ‖} \qquad ( 1 )$$

In such an embodiment, if cosine similarity is close to 1.0, the reasons are considered nearly identical and thus similar and may be merged as discussed. If cosine similarity is below a threshold (e.g., 0.5), the reasons are distinct enough to be considered dissimilar and are retained separately. System 102 may use this metric and approach to cluster semantically similar reasons together.

### Step 3: Computing Average Similarity

For each reason rᵢ, system 102 calculates mi, which represents the average similarity of that reason to all reasons (including itself) in sample reason set 210. This helps in quantifying redundancy. Average similarity for a reason rᵢ may be determined as follows.

$${m}_{i} = \frac{1}{k} {\sum }_{j = 1}^{k} {v}_{i} \cdot {v}_{j} \qquad ( 2 )$$

where:
k is the total number of sampled reasons.
vᵢ is the vector representation of reason i.
vⱼ represents each other reason's vector.
vᵢ*vⱼ is the dot product, which gives cosine similarity.

### Step 4: Identifying Redundant and Overlapping Reasons

After computing similarity scores, system 102 groups related reasons that share a similarity score above a predefined threshold (e.g., ≥0.9 cosine similarity). For example, applying cosine similarity filtering to the above stock market volatility example:

Applying cosine similarity filtering to our stock market volatility example:

| | | Cosine |
|---|---|---|
| Sample Reason | Most Similar Reason | Similarity |
| 1. “Investor sentiment | 38. “Market speculation | 0.92 |
| brings market speculation, | leads to price swings due | |
| leading to price swings.” | to investor sentiment.” | |
| 5. “Geopolitical events | 27. “Geopolitical | 0.91 |
| introduce uncertainty, | events increase volatility | |
| increasing volatility.” | due to increased | |
| | uncertainty.” | |
| 6. “Supply chain | 19. “Disruptions to | 0.89 |
| disruptions impact | supply chains affect price | |
| company revenues and | movement and company | |
| stock performance.” | revenues.” | |

Using this analysis:
1. Reason (1) and Reason (38) are merged (both relate to investor speculation and trading behavior).
2. Reason (5) and Reason (27) are merged (both relate to macroeconomic uncertainty).
3. Reason (6) and Reason (19) are merged (both deal with supply chain disruptions affecting stock movement).

This can effectively reduce redundancy while maintaining reasoning diversity.

### Step 5: Filtering Out Low-Quality Reasons

To ensure high-quality reasoning paths, system 102 may apply additional filtering criteria, such as: frequency thresholding (e.g., removing reasons that appear only once if they are not highly distinct), contradiction detection (e.g., flagging reasons that provide conflicting logical paths), or response truncation (e.g., limiting overly verbose reasons to a concise format).

### Step 6: Output-Distinct Reasons for Further Processing

As a result of the processing for generating a sampling of reasons, such as filtering and merging redundant responses, the system may output a set of distinct, high-quality reasons in a preliminary reduced reason set. For the stock market volatility example, the preliminary reduced reason set may be as follows:
1. “Speculative trading and short-selling contribute to stock market volatility.”
2. “Interest rate changes affect stock valuations and investor confidence.”
3. “Earnings reports introduce volatility by setting investor expectations.”
4. “Algorithmic trading amplifies small market movements.”
5. “Geopolitical instability and Federal Reserve decisions amplify market fluctuations.”
6. “Supply chain disruptions and corporate actions impact stock performance.”

In such an embodiment, the preliminary reduced reason set may be further processed by reason reduction module 212, where combinatorial optimization techniques, such as QUBO or Ising models, are applied to continue the reason selection process and ultimately generate the reduced reason set 214.

In some embodiments, determining a reduced set of reasons includes applying a multi-stage processing pipeline to a set of sample reasons. This may include vectorizing individual reasons to generate embeddings in a high-dimensional space, comparing those embeddings to identify semantic similarity, and clustering responses that are redundant or closely related. The system may then generate a set of distinct reasons by reducing groups of similar responses into representative reasons and combining them with remaining unique responses. The resulting distinct reasons may include: (i) a first subset corresponding to the unique individual responses and (ii) a second subset corresponding to reduced individual reasons derived from clustered similar responses. As described, a cost function (e.g., used in a QUBO formulation) may then be applied to the distinct reasons to select a final reduced set of reasons that balances informativeness and diversity while minimizing redundancy. This structured process enables consistent, high-quality prompt construction from diverse model outputs.

### QUBO Mapping

In some embodiments, after reason reduction module 212 has filtered distinct reasoning paths, system 102 selects an optimal subset of reasons that will be used to construct the final execution prompt 218. This may involve system 102 applying a cost-function optimization, such as mapping the selection problem into a Quadratic Unconstrained Binary Optimization (QUBO) problem. This may allow balancing reason selection based on frequency, diversity, and informativeness, using efficient combinatorial solvers (e.g., Ising Machines) to optimize selection. In some embodiments, the QUBO mapping includes the following: assigning binary decision variables to reasons; defining an objective function with linear and quadratic (or higher order) terms; and solving the QUBO problem to find the optimal subset of reasons, as described here or as described in U.S. Provisional Patent Applications 63/571,220, 63/571,229, and 63/571,233, which are each incorporated by reference.

### Step 1: Assigning Binary Decision Variables to Reasons

Each distinct reason rᵢ from reduced reason set 214 is assigned an integer variable zᵢ, which encodes its selection weight. System 102 represents zᵢ in binary form:

$${z}_{i} = {\sum }_{w = 0}^{W - 1} {2}^{w} {x}_{iw} \qquad ( 3 )$$

where:
x_{iw} are binary variables (either 0 or 1).
W is the maximum power of 2 allowed in encoding.

As such, each reason may be represented as a sum of binary variables, allowing flexible weighting in selection and enabling compatibility with binary optimization solvers used in QUBO formulations.

In some embodiments, the combinatorial optimization framework used to determine the reduced set of reasons formulates each candidate reason as a variable encoded in binary form (e.g., 0 or 1), representing whether the reason is selected or not. The framework applies a cost function (e.g., quadratic, such as QUBO, and higher-order, such as Ising) defined over these binary variables, where the cost function includes linear terms corresponding to individual relevance scores (e.g., based on frequency or distinctiveness) and terms representing pairwise similarity or redundancy penalties between candidate reasons. The optimization objective is to minimize the overall cost function to identify a subset of reasons that maximizes informativeness and diversity while minimizing redundancy. This formulation may be expressed as a Quadratic Unconstrained Binary Optimization (QUBO) problem or an equivalent Ising model.

### Step 2: Linear Term L-Prioritizing High-Frequency Reasons

The linear term L favors reasons that appear frequently and are highly relevant:

$$L = {\sum }_{i} {l}_{i} ( μ , α ) {z}_{i} \qquad ( 4 )$$

$$where :$$

$${l}_{i} ( μ , α ) = μ {p}_{i} - α {r}_{i} \qquad ( 5 )$$

pᵢ=relative frequency of reason rᵢ in sample reason set.
rᵢ=standard deviation of pᵢ across sampled responses.
μ and α are tunable parameters to adjust weighting.

Continuing with the example application concerning stock market volatility, the following are example popularity and lᵢ(μ,α) values (or “scores”), which reflect how often each reason appears in the sample reason set:

| Reason | Popularity pᵢ | lᵢ(μ, α) Score |
|---|---|---|
| “Speculative trading and short-selling | 0.85 | High |
| contribute to stock market volatility.” | | |
| “Interest rate changes affect stock | 0.73 | Medium |
| valuations and investor confidence.” | | |
| “Earnings reports introduce volatility | 0.78 | Medium- |
| by setting investor expectations.” | | High |

Notably, higher lᵢ(μ,α) values (or “scores”) increase the likelihood of selection, as they indicate reasons that are both prevalent and statistically consistent across sampled responses.

### Step 3: Quadratic Term Q-Penalizing Redundant Reasons

The quadratic term Q. This quadratic term Q is decided by how many times two reasons occur together in different samples. It maximizes quadratic terms-a consistency, prioritizing reason pairs that consistently appear together within samples:

$$Q = {\sum }_{i \neq j} {q}_{ij} ( λ ) {z}_{i} {z}_{j} \qquad ( 6 )$$

$$where :$$

$${q}_{ij} ( λ ) = {c}_{ij} - \overline{c} - {λσ}_{c} \qquad ( 7 )$$

cᵢⱼ=empirical correlation between reasons rᵢ and rⱼ.
c=mean correlation across all sampled reasons.
σ_{c}=standard deviation of cᵢⱼ.
λ=tunable hyperparameter.

Continuing with the example application concerning stock market volatility, the following are example correlations between similar reasons:

| Reason rᵢ | Most Similar Reason rⱼ | Correlation cᵢⱼ |
|---|---|---|
| “Speculative trading and | “Algorithmic trading | 0.92 |
| short-selling contribute to | amplifies small market | |
| stock market volatility.” | movements.” | |
| “Geopolitical instability | “Interest rate changes | 0.88 |
| and Federal Reserve decisions | affect stock valuations | |
| amplify market fluctuations.” | and investor confidence.” | |

Notably, if cᵢⱼ is relatively high, the solver encourages selecting both reasons, as they are more likely to be consistent with each other.

### Step 4: Solving the QUBO Problem

The QUBO objective function may be represented as follows:

$$H = - ( Q + L ) \qquad ( 8 )$$

such that,

$$H = - ( {\sum }_{i} ( μ {p}_{i} - α {r}_{i} ) {z}_{i} + {\sum }_{i \neq j} ( {c}_{ij} - \overline{c} - {λσ}_{c} ) {z}_{i} {z}_{j} ) \qquad ( 9 )$$

Notably, the first term prioritizes popular reasons, and the second term prioritizes reason pairs that consistently appear together within samples. Here, H is a cost function that is minimized in the optimization. In some embodiments, system 102 solves this optimization problem using a combinatorial optimization technique, such as but not limited to conventional discrete variable solvers such as simulated annealing and parallel tempering; quantum-inspired solvers such as digital annealing; quantum computers such as quantum annealers or gate-based hardware systems, and Ising machines such as coherent Ising machines.

### Step 5: Extracting the Optimal Reason Set-How and Why Reasons Are Selected

Once the QUBO problem is solved, system 102 selects the optimal subset of reasons that balance informativeness, diversity, and consistency. This selection is driven by the objective function H (e.g., in Step 4), ensuring that high-frequency, informative reasons are prioritized, redundant reasons are removed (e.g., removed in the prior QUBO step), and logically conflicting reasons are filtered out. The linear term L in the objective function rewards reasons that appear frequently in sample reason set 210, as more frequent reasons are assumed to be highly relevant to the query. Meanwhile, the quadratic term Q encourages the selection of consistent reasons and penalizes reason pairs that are too similar, ensuring that the selected reasons provide diverse perspectives rather than repeating the same information in different wording.

To illustrate how reasons are selected, consider the stock market volatility example and the following computed scores for each reason and a discussion thereof:

| | Popularity | Selection |
|---|---|---|
| Candidate Reason | pᵢ | Decision |
| “Speculative trading and short-selling | 0.85 | Selected |
| contribute to stock market volatility.” | | |
| “Interest rate changes affect stock | 0.73 | Selected |
| valuations and investor confidence.” | | |
| “Earnings reports introduce volatility by | 0.78 | Selected |
| setting investor expectations.” | | |
| “Algorithmic trading amplifies small | 0.74 | Removed |
| market movements.” | | |
| “Geopolitical instability and Federal | 0.81 | Selected |
| Reserve decisions amplify market | | |
| fluctuations.” | | |
| “Supply chain disruptions and corporate | 0.72 | Selected |
| actions impact stock performance.” | | |

System 102 computes popularity scores (pᵢ) and consistency scores (qᵢⱼ) for each candidate reason. For instance, the reason “Speculative trading and short-selling contribute to stock market volatility” has a high popularity score, making it a strong candidate for selection. Similarly, “Interest rate changes affect stock valuations and investor confidence” is distinct, has moderate frequency, and provides an essential reasoning path. In contrast, “Algorithmic trading amplifies small market movements” is highly correlated with the speculative trading reason, leading to its removal in favor of the more general and frequently occurring speculative trading reason. A similar process occurs when considering “Geopolitical instability and Federal Reserve decisions amplify market fluctuations,” which is selected due to its distinct perspective on macroeconomic uncertainty. Meanwhile, reasons that are closely related, such as supply chain disruptions and stock buybacks, may be consolidated into a single representative reason describing how corporate actions impact stock market performance. Ultimately, after solving the QUBO problem, system 102 selects the most optimal set of reasons that maintain reasoning diversity while minimizing redundancy.

### Combinatorial Optimization Solving

In some embodiments, once the QUBO problem has been formulated (e.g., as described above), system 102 determines the optimal subset of reasons from an initially reduced reason set to be used in the final reduced reason set 214 for the execution prompt 218. This selection may, for example, be performed by a combinatorial optimization solver, which efficiently finds the low energy states of the QUBO objective function. Given that QUBO problems are NP-hard, finding an exact solution at scale can be computationally expensive. In some embodiments, system 102 employs approximate solvers, such as simulated annealing or Ising machines, to produce solution distributions (e.g., Boltzmann distributions) to obtain a diverse set of near-optimal selections in a reasonable time.

In such an embodiment, the solver may begin by encoding the QUBO objective function into a binary optimization framework, where each reason is represented as a binary decision variable zᵢ. The solver then iteratively adjusts zᵢ values to minimize the total cost function H. The goal is to find a balance where the final set of reasons captures distinct perspectives while avoiding redundancy.

Different cost-optimization techniques may be employed to solve this problem. Simulated annealing may mimic the physical process of metal cooling, allowing system 102 to initially explore diverse selections of reasons before gradually settling into an optimized subset as the solution “cools.” Alternatively, Ising machines may encode the QUBO problem as a network of interacting spins, which naturally evolves toward a low-energy configuration that represents an optimal reasoning set. These solvers may enable fast and efficient optimization, ensuring that only the most relevant and distinct reasoning paths are selected.

An example of the final selected reasons for reduced reason set 214 is shown in the table below. This optimized set may represent the most distinct, relevant, and non-redundant reasons, which are then passed to execution prompt module 216 for final response generation.

### Example Final Selected Reasons for Execution Prompt Module 216:

| | Popularity |
|---|---|
| Selected Reason | Score pᵢ |
| “Speculative trading and short-selling contribute to stock | 0.77 |
| market volatility.” | |
| “Interest rate changes affect stock valuations and investor | 0.89 |
| confidence.” | |
| “Earnings reports introduce volatility by setting investor | 0.85 |
| expectations.” | |
| “Geopolitical instability and Federal Reserve decisions | 0.82 |
| amplify market fluctuations.” | |
| “Supply chain disruptions and corporate actions impact stock | 0.73 |
| performance.” | |

By leveraging combinatorial optimization, system 102 may, in turn, automatically select a structured subset of reasons that maximize informativeness, reasoning diversity, and logical consistency. In some embodiments, the final selected reasons are passed to execution prompt module 216 in as the reduced reason set 214, ensuring that the most informative, distinct, and logically sound reasoning paths are preserved for final response generation. By applying combinatorial optimization, system 102 can automatically balance informativeness and diversity, ensuring that the generated response is cohesive, well-reasoned, and free from unnecessary repetition.

### Execution Prompt Generation

In some embodiments, execution prompt module 216 is operable to generate execution prompt 218 based on reduced reason set 214. This may include formatting the selected reasons into a structured prompt, appending a query (e.g., that is the same as or otherwise corresponds to query 112), and applying additional query parameters or context refinements to enhance response quality. Once execution prompt 218 is constructed, it is submitted to LLM 108, which generates a corresponding query response 114. In some embodiments, execution prompt 218 include multiple, individual prompts that may be executed independently or in coordination. Since the execution prompt has already undergone processing in reason reduction module 212, it provides LLM 108 with a well-structured, optimized input that reduces hallucinations, logical inconsistencies, and unnecessary repetition. Thus, execution prompt module 216 ensures that LLM 108 receives an optimized prompt that is logically structured, diverse, and free from redundancy, thereby improving the accuracy and coherence of query response 114.

In some embodiments, execution prompt module 216 formats execution prompt 218 by structuring reduced reason set 214 and query 112 into a coherent, model-friendly input. This formatting can ensure that the prompt 218 maintains contextual integrity while aligning with the response-generation capabilities of LLM 108. The execution prompt may include a preamble that introduces the reasoning process, a structured listing of selected reasons from reduced reason set 214 (an “execution” set of reasons), and a restatement of the original query (an “execution” query) to ensure that the final response remains directly relevant to the user's input. The following is an example of execution prompt 218 for the stock market volatility example:

“The following factors contribute to stock market volatility based on historical patterns and economic analysis: speculative trading and short-selling contribute to stock market volatility; interest rate changes affect stock valuations and investor confidence; earnings reports introduce volatility by setting investor expectations; geopolitical instability and Federal Reserve decisions amplify market fluctuations; and supply chain disruptions and corporate actions impact stock performance. Given these factors, please provide an analysis of stock market volatility and its potential implications for investors.”

### Prompt Execution and Response Generation

In some embodiments, once execution prompt module 216 has assembled execution prompt 218, it is submitted to LLM 108, which processes the input and generates query response 114. Because the execution prompt has already undergone rigorous preprocessing, the LLM is less likely to generate redundant information, as the reasoning paths have already been optimized. Additionally, since the combinatorial solver removed inconsistent or contradictory reasons, the final response is less likely to include conflicting logic. The risk of hallucinated justifications may also be minimized, as the selected reasons have been filtered through a structured, optimization-based selection process.

For example, after processing the example execution prompt 218 for the stock market volatility example, LLM 108 may generate query response 114. This may take various forms depending on the application. In some embodiments, the response is a natural language explanation that summarizes key insights related to the query, a structured report that presents data-driven analysis, a set of action recommendations tailored to decision-making needs, or the like. The following is an example response to the example execution prompt 218 for the stock market volatility analysis:

Stock market volatility is influenced by multiple factors that interact in complex ways, shaping investor behavior and market trends. Below is an analysis of key contributors to volatility and their potential implications for investors:

### 1. Speculative Trading and Short-Selling:

Speculative trading often amplifies market volatility by driving rapid price fluctuations based on investor sentiment rather than fundamental economic data. Short-selling can further contribute to volatility by increasing downward price pressure during market downturns, leading to sharp corrections. While speculation provides liquidity to markets, it can also result in unpredictable price swings that create risk for long-term investors.

### 2. Interest Rate Changes and Market Valuations:

Adjustments in interest rates directly affect stock valuations and investor confidence. When central banks raise rates, borrowing becomes more expensive, reducing corporate profitability and leading to declining stock prices. Conversely, rate cuts tend to stimulate investment, causing equity markets to rise. Interest rate uncertainty often results in heightened volatility as investors adjust their portfolios in response to anticipated policy changes.

### 3. Earnings Reports and Market Expectations:

Quarterly earnings reports play a significant role in market fluctuations. Unexpected results—whether positive or negative—can trigger sharp stock price movements as markets adjust to revised expectations. Positive earnings surprises often lead to buying pressure, while disappointing reports can lead to sell-offs. High volatility during earnings season reflects the rapid reassessment of corporate financial health and future prospects.

### 4. Geopolitical Instability and Federal Reserve Decisions:

Global events, such as political conflicts, trade negotiations, and economic sanctions, introduce uncertainty that leads to market volatility. Federal Reserve policies, including monetary stimulus or tightening measures, further influence investor sentiment by shaping inflation expectations and liquidity conditions. In times of uncertainty, investors often shift toward safer assets, leading to increased fluctuations in equity markets.

### 5. Supply Chain Disruptions and Corporate Actions:

Supply chain bottlenecks, labor shortages, and trade restrictions can impact corporate revenues and profit margins, leading to volatility in affected sectors. Additionally, corporate actions such as stock buybacks or dividend changes can influence market sentiment. Buybacks reduce the number of shares outstanding, potentially driving up stock prices, while dividend cuts may signal financial distress, leading to increased uncertainty.

### Implications for Investors:

Given these factors, investors should consider portfolio diversification to hedge against volatility. Monitoring macroeconomic indicators, corporate earnings trends, and central bank policies can help anticipate market shifts. Additionally, long-term investment strategies that focus on fundamentals rather than short-term price movements can mitigate the risks associated with speculative trading and geopolitical uncertainty.

Notably, the response is structured logically, following the format established in execution prompt 218 to ensure clarity and coherence. Each selected reason from reduced reason set 214 is expanded into a detailed and informative discussion, providing depth to the analysis while maintaining a well-organized flow. The response effectively eliminates redundancy by focusing on distinct reasoning paths, ensuring that each factor contributes new insights rather than repeating similar ideas. Additionally, the response provides actionable insights, making it valuable for investors who seek to understand and mitigate risks associated with stock market volatility.

In some embodiments, response 114 is provided to user 104. For example, combinatorial reasoning engine 106 may provide the above response 114 to user 104 in response to the user 104 submitting the query 112 “Explain the key factors influencing stock market volatility”. Embodiments of the techniques may ensure that the user 104 is provided with a response 114 that is optimized, informative, and structured according to the reasoning process established. The response may be used to simply inform the user 104, or, for example, may be used to instigate an action, such as a control context where response 114 includes control parameters that are automatically employed to control operation of a system. For instance, in a financial risk management platform, response 114 may include a recommended portfolio reallocation based on detected market volatility factors, which is then automatically applied to rebalance asset holdings in accordance with predefined thresholds.

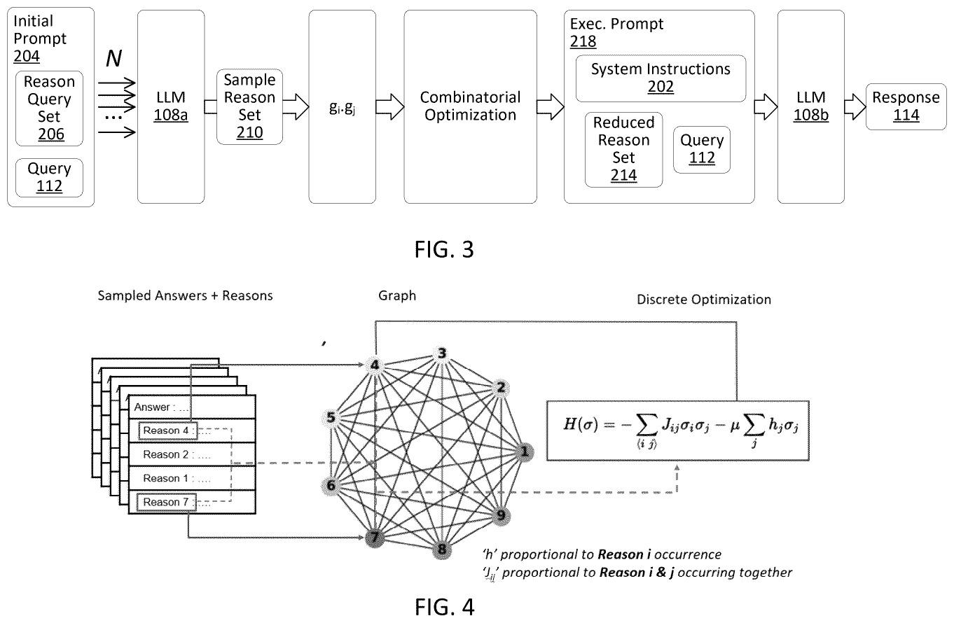

FIGS. 3 and 4 are diagrams that illustrate operational aspects of combinatorial reasoning engine 106 in accordance with one or more embodiments and may be viewed as providing additional detail with respect to the components and workflow depicted in FIG. 2. Referring first to FIG. 3, the diagram illustrates how an initial prompt 204—constructed based on system instructions 202 and query 112—is used to generate a reason query set 206 comprising multiple (N) identical or equivalent reason queries. These queries are submitted in parallel to a first language model instance, LLM 108a, which returns a corresponding sample reason set 210. The sample reason set 210 is then provided to reason reduction module 212, which performs semantic filtering, similarity analysis, and optimization to eliminate redundancy and preserve reasoning diversity.

Still referring to FIG. 3, the resulting distinct reasoning candidates are then subjected to a combinatorial optimization process that includes QUBO mapping and solving. The outcome of this process is a reduced reason set 214, which represents a selection of the most informative and consistent reasons. This reduced reason set 214, along with query 112 (or a reformulated version thereof), is passed to execution prompt module 216 to construct execution prompt 218. Execution prompt 218 is then submitted to a second instance of the language model, LLM 108b, which may be the same as or different from LLM 108a. The output of LLM 108b is a final answer or explanation, which is then formulated into query response 114, as described previously in connection with FIG. 2.

FIG. 4 provides additional detail regarding the combinatorial optimization stage shown in FIG. 3, specifically the mapping and solving of the reasoning selection problem using a Quadratic Unconstrained Binary Optimization (QUBO) framework. As shown, reasons are encoded as nodes in a graph, where edges represent pairwise correlations (e.g., consistency) between candidate reasons. A QUBO objective function is constructed to assign binary selection weights to candidate reasons in a way that maximizes individual relevance while maximizing consistency. This is accomplished by solving for the lowest-energy configuration over the graph, which may be implemented using a discrete optimization technique such as simulated annealing or executed on specialized hardware such as an Ising machine. The output of this optimization is the reduced reason set 214, which ensures that only distinct, relevant, and contextually appropriate reasoning paths are retained for prompt construction.

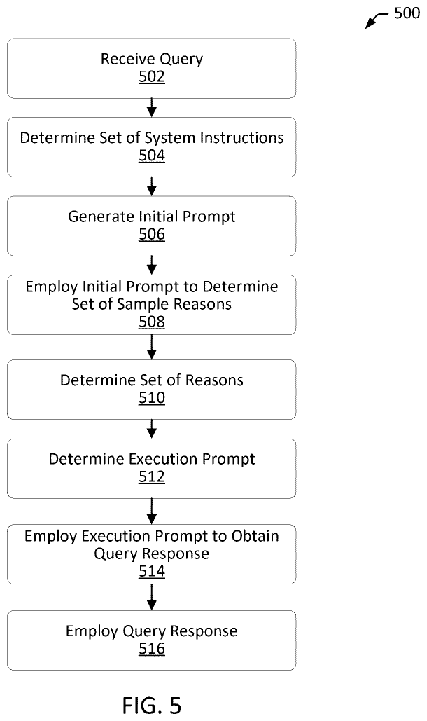

FIG. 5 is a flowchart diagram that illustrates a method 500 of combinatorial reasoning-based generative intelligence in accordance with one or more embodiments. Some or all of the procedural elements of method 500 may be performed, for example, by system 102, including combinatorial reasoning engine 106 and LLM 108, or by another suitable computing system or other entity.

Method 500 may include receiving a query (block 502). This may include receiving a user-submitted query. For example, receiving a query may include initial prompt module 200 of combinatorial reasoning engine 106 receiving query 112, such as “Explain the key factors influencing stock market volatility,” submitted by user 104.

Method 500 may include determining a set of system instructions (block 504). This may include receiving a set of system instructions that define parameters for processing a query. For example, determining a set of system instructions may include initial prompt module 200 of combinatorial reasoning engine 106, in response to receiving query 112 (e.g., “Explain the key factors influencing stock market volatility”), identifying system instructions 202 that specify: N=10; Temperature=0.5; Output format=bullet points; and Required data sources=historical S&P 500 trends.

Method 500 may include generating an initial prompt (block 506). This may include generating an initial prompt based on a query and a set of system instructions that define parameters for processing the query. For example, generating an initial prompt may include initial prompt module 200 of combinatorial reasoning engine 106, in response to receiving query 112 and having identified system instructions 202, generating an initial prompt that includes system instructions corresponding to system instructions 202, a reason query set 206 corresponding to query 112, and additional parameters, such as temperature, output length, formatting, or the like, such as those described here with regard to at least FIG. 2. Initial prompt module 200 may provide the initial prompt 204 to LLM module 208.

Method 500 may include employing an initial prompt to determine a set of sample reasons (block 508). This may include submitting an initial prompt to an LLM or similar model to obtain a set of sample reasons. For example, employing the initial prompt to determine a set of sample reasons may include LLM module 208 submitting initial prompt 204 to LLM 108 to cause LLM 108 to provide a sample reason set 210 (in response to receiving initial prompt 204), and LLM module 208 providing the sample reason set 210 to reason reduction module 212. Continuing with the above example, the LLM response may include 100 responses (or “reasons”), such as those described here with regard to at least FIG. 2. LLM module 208 may assemble those ten responses into a sample reason set 210 and provide the sample reason set 210 to reason reduction module 212.

Method 500 may include determining a set of reasons (block 510). This may include applying cost function-based optimization techniques, such as Quadratic Unconstrained Binary Optimization (QUBO) and Ising models, to select an optimized set of reasons from a set of sample reasons. For example, determining a set of reasons may include reason reduction module 212 conducting combinatorial reasoning that includes processing sample reason set 210 as discussed here. This may include, for example, embedding and clustering similar responses, computing average similarity scores, applying QUBO-based optimization to balance informativeness and diversity, and selecting a final subset of distinct, non-redundant reasons to generate reduced reason set 214, such as those described here with regard to at least FIG. 2. Reason reduction module 212 may provide the reduced reason set 214 to execution prompt module 216.

Method 500 may include determining an execution prompt (block 512). This may include determining an execution prompt based on a reduced reason set and an associated query. For example, determining an execution prompt may include execution prompt module 216 generating an execution prompt 218 that includes a set of reasons that are the same or similar to those of reduced reason set 214 and a query that is the same or similar to query 112, such as those described here with regard to at least FIG. 2.

Method 500 may include employing an execution prompt to obtain a query response (block 514). This may include submitting an execution prompt to an LLM or similar model to obtain a response. For example, employing an execution prompt to obtain a query response may include LLM module 208 submitting the execution prompt 218 to LLM 108 to cause LLM 108 to provide a response 114 (in response to receiving execution prompt 218), such as that described here with regard to at least FIG. 2.

Method 500 may include employing a query response (block 516). This may include providing a response to an execution prompt to a user for use. For example, employing a query response may include LLM module 208 providing response 114 to user 104 in response to user 104 submitting the query 112 (e.g., “Explain the key factors influencing stock market volatility”). Embodiments of the techniques may ensure that the user 104 is provided with a response 114 that is optimized, informative, and structured according to the reasoning process established. The response may be used to, for example, inform the user 104, to instigate an action, such as a control context where response 114 includes control parameters that are automatically employed to control operation of a system, or the like, such as that described here with regard to at least FIG. 2.

The disclosed combinatorial reasoning system introduces several technological improvements over conventional large language model (LLM) reasoning frameworks. By integrating combinatorial optimization techniques, including Quadratic Unconstrained Binary Optimization (QUBO) and Ising-based solvers, the system can enhance response accuracy, computational efficiency, and adaptability, while reducing reliance on manual prompt engineering and extensive model pre-training. Unlike traditional LLM-based reasoning approaches that rely on static, human-curated examples, this system may dynamically construct and optimizes reasoning paths to improve LLM output quality without requiring fine-tuned models. This can reduce the computational overhead associated with re-training large models for specialized tasks, making the system more scalable and cost-effective.

Performance benchmarking of the combinatorial reasoning system on reasoning-intensive tasks demonstrates notable improvements in accuracy, processing speed, and reasoning diversity compared to conventional zero-shot prompting methods. Experimental evaluations show that the system outperforms baseline zero-shot and other prompting methods, particularly in NLP-based reasoning tasks. The results indicate that by applying semantic filtering, vector-based clustering, and optimization-based selection, the system can effectively remove redundant reasoning paths while preserving logical coherence. Additionally, experimental comparisons with standard simulated annealing solvers highlight that employing specialized hardware solvers, such as Ising Machines and Fujitsu Digital Annealers, can significantly reduce computational time while maintaining or improving response quality.

The use and combination of semantic embeddings, discrete optimization, and automated prompt engineering, such as those described, may provide substantial improvements in computational efficiency, reducing test-time compute overhead while improving the reliability of reasoning outputs. Further, sampling may be parallelized, which can provide relatively low response latency for a given compute cost. These advancements minimize human intervention, lower inference costs, and enhance the system's ability to generalize across diverse problem domains, making it a practical and scalable approach for real-world AI reasoning applications.

FIG. 6 is a diagram that illustrates an example computer system (or “system”) 1000 in accordance with one or more embodiments. System 1000 may include memory 1004, processor 1006, and an input/output (I/O) interface 1008. Memory 1004 may include non-volatile memory (e.g., flash memory, read-only memory (ROM), programmable read-only memory (PROM), erasable programmable read-only memory (EPROM), electrically erasable programmable read-only memory (EEPROM)); volatile memory (e.g., random access memory (RAM), static random access memory (SRAM), synchronous dynamic RAM (SDRAM)); or bulk storage memory (e.g., CD-ROM or DVD-ROM, hard drives). Memory 1004 may include a non-transitory computer-readable storage medium having program instructions 1010 stored on the medium. Program instructions 1010 may include program modules 1012 that are executable by processor 1006 to cause the functional operations described, such as those described with regard to the entities (e.g., generative intelligence system 102, user 104, combinatorial reasoning engine 106 (or any modules thereof), large language model (LLM) 108, or the like) or method 500. In some embodiments, system 1000 includes combinatorial optimization hardware, such as a quantum computer (e.g., a quantum annealers or gate-based hardware system), or an Ising machine (e.g., a coherent Ising machine).

Processor 1006 may be any suitable processor capable of executing program instructions. Processor 1006 may include one or more processors that carry out program instructions (e.g., program instructions of program modules 1012) to perform arithmetical, logical, and input/output operations described. Processor 1006 may include multiple processors that can be grouped into one or more processing cores each containing a group of one or more processors used for executing the processing described herein, such as independent parallel processing of partitions (or “sectors”) by different processing cores. I/O interface 1008 may provide an interface for communication with one or more I/O devices 1014, such as a joystick, a computer mouse, a keyboard, or a display screen (e.g., an electronic display for displaying a graphical user interface (GUI)). I/O devices 1014 may include one or more user input devices. I/O devices 1014 may be connected to I/O interface 1008 by way of a wired connection (e.g., an Industrial Ethernet connection) or a wireless connection (e.g., a Wi-Fi connection). I/O interface 1008 may provide an interface for communication with one or more external devices 1016, computer systems, servers, or electronic communication networks. In some embodiments, I/O interface 1008 includes an antenna or a transceiver.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described here are to be taken as examples of embodiments. Elements and materials may be substituted for those illustrated and described here, parts and processes may be reversed or omitted, and certain features of the embodiments may be utilized independently, all as would be apparent to one skilled in the art after having the benefit of this description of the embodiments. Changes may be made in the elements described here without departing from the spirit and scope of the embodiments as described in the following claims. Headings used here are for organizational purposes only and are not meant to be used to limit the scope of the description.

It will be appreciated that the processes and methods described here are example embodiments of processes and methods that may be employed in accordance with the techniques described here. The processes and methods may be modified to facilitate variations of their implementation and use. The order of the processes and methods and the operations described may be changed, and various elements may be added, reordered, combined, omitted, modified, and so forth. Portions of the processes and methods may be implemented in software, hardware, or a combination thereof. Some or all of the portions of the processes and methods may be implemented by one or more of the processors/modules/applications described here.

As used throughout this application, the word “may” is used in a permissive sense (meaning having the potential to), rather than the mandatory sense (meaning must). The words “include,” “including,” and “includes” mean including, but not limited to. As used throughout this application, the singular forms “a,” “an,” and “the” include plural referents unless the content clearly indicates otherwise. Thus, for example, reference to “an element” may include a combination of two or more elements. As used throughout this application, the term “or” is used in an inclusive sense, unless indicated otherwise. That is, a description of an element including A or B may refer to the element including one or both of A and B. As used throughout this application, the phrase “based on” does not limit the associated operation to being solely based on a particular item. Thus, for example, processing “based on” data A may include processing based at least in part on data A and based at least in part on data B, unless the content clearly indicates otherwise. As used throughout this application, the term “from” does not limit the associated operation to being directly from. Thus, for example, receiving an item “from” an entity may include receiving an item directly from the entity or indirectly from the entity (e.g., by way of an intermediary entity). Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical, electronic or magnetic quantities within memories, registers, or other information storage devices, transmission devices, or display devices of the special purpose computer or similar special purpose electronic processing/computing device.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading based on the way in which those terms are used in other materials incorporated by reference.

What is claimed is:

1. A reasoning generative intelligence system comprising:
a reasoning engine configured to:
receive a query;
determine a set of system instructions corresponding to the query;
generate, based on the query and the set of system instructions, an initial prompt comprising a set of reason queries;
submit the initial prompt to a first large language model (LLM) to obtain a set of sample reasons corresponding to the set of reason queries;
determine, based on application of optimization to the set of sample reasons, a reduced set of reasons;
generate, based on the reduced set of reasons, an execution prompt;
submit the execution prompt to a second LLM to obtain a query response; and
employ the query response in response to the query.

2. The system of claim 1, wherein determining the reduced set of reasons comprises applying of a combinatorial or continuous optimization framework that employs a quadratic or higher order cost function.

3. The system of claim 1, wherein determining the reduced set of reasons comprises applying Quadratic Unconstrained Binary Optimization (QUBO).

4. The system of claim 1, wherein determining the reduced set of reasons comprises applying a quadratic or higher order Ising model.

5. The system of claim 1, wherein determining the reduced set of reasons comprises utilizing more than one low-energy solutions in the form of a solution distribution from an optimizer.

6. The system of claim 1,
wherein the submitting of the initial prompt comprises submission of individual reason queries of the set of reason queries to the LLM;
wherein the set of sample reasons comprises individual reasons generated responsive to the individual reason queries submitted to the LLM,
wherein determining a reduced set of reasons comprises:
vectorizing the individual reasons to generate a reason vector set comprising reason vectors for the individual reasons;
determining, based on a comparison of the reason vectors:
a set of similar individual reasons that comprises two or more reasons of the set of sample reasons that are similar; and
a set of unique individual reasons that comprises one or more of the reasons of the set of sample reasons that are distinct from other reasons of the set of sample reasons;
generating, based on the set of similar individual reasons, a reduced individual reason that corresponds to the two or more reasons of the set of sample reasons that are similar;
generating, based on the set of unique individual reasons and the reduced individual reasons, a set of distinct reasons, the set of distinct reasons comprising:
a first subset of distinct reasons corresponding to the set of unique individual reasons; and
a second subset of the distinct reasons corresponding to the reduced individual reason; and
applying a cost function to the set of distinct reasons to determine the reduced set of reasons.

7. The system of claim 1, wherein the set of system instructions defines a number of reason queries to be included in the set of reason queries and a temperature parameter configured to control a level of response diversity for the set of reason queries.

8. The system of claim 1,
wherein the set of reason queries comprises a given number (N) of input prompts, where N is greater than 1,
wherein the set of sample reasons comprises reasons generated by the first LLM in response to the respective N input prompts, and
wherein the reduced set of reasons comprises distinct reasons generated based on the reasons.

9. The system of claim 1, wherein the execution prompt comprises:
an execution set of reasons that correspond to the reduced set of reasons; and
an execution query that corresponds to the query.

10. The system of claim 1, wherein the query is submitted by a user and employing the query response comprises providing the query response to the user in response to the query, or wherein employing the query response comprises controlling a system based on the query response.

11. The system of claim 1, the reasoning engine configured to dynamically select parameters for the optimization.

12. The system of claim 1, further comprising of a combinatorial optimization hardware, wherein the reasoning engine is executed on the combinatorial optimization hardware.

13. A method of reasoning generative intelligence comprising:
receiving a query;
determining a set of system instructions corresponding to the query;
generating, based on the query and the set of system instructions, an initial prompt comprising a set of reason queries;
submitting the initial prompt to a first large language model (LLM) to obtain a set of sample reasons corresponding to the set of reason queries;
determining, based on application of optimization to the set of sample reasons, a reduced set of reasons;
generating, based on the reduced set of reasons, an execution prompt;
submitting the execution prompt to a second LLM to obtain a query response; and
employing the query response in response to the query.

14. The method of claim 13, wherein determining the reduced set of reasons comprises applying of a combinatorial or continuous optimization framework that employs a quadratic or higher order cost function.

15. The method of claim 13, wherein determining the reduced set of reasons comprises applying Quadratic Unconstrained Binary Optimization (QUBO).

16. The method of claim 13, wherein determining the reduced set of reasons comprises applying a quadratic or higher order Ising model.

17. The method of claim 13, wherein determining the reduced set of reasons comprises utilizing more than one low-energy solutions in the form of a solution distribution from an optimizer.

18. The method of claim 13,
wherein the submitting of the initial prompt comprises submission of individual reason queries of the set of reason queries to the LLM;
wherein the set of sample reasons comprises individual reasons generated responsive to the individual reason queries submitted to the LLM,
wherein determining a reduced set of reasons comprises:
vectorizing the individual reasons to generate a reason vector set comprising reason vectors for the individual reasons;
determining, based on a comparison of the reason vectors:
a set of similar individual reasons that comprises two or more reasons of the set of sample reasons that are similar; and
a set of unique individual reasons that comprises one or more of the reasons of the set of sample reasons that are distinct from other reasons of the set of sample reasons;
generating, based on the set of similar individual reasons, a reduced individual reason that corresponds to the two or more reasons of the set of sample reasons that are similar;
generating, based on the set of unique individual reasons and the reduced individual reasons, a set of distinct reasons, the set of distinct reasons comprising:
a first subset of distinct reasons corresponding to the set of unique individual reasons; and
a second subset of the distinct reasons corresponding to the reduced individual reason; and
applying a cost function to the set of distinct reasons to determine the reduced set of reasons.

19. The method of claim 13, wherein the set of system instructions defines a number of reason queries to be included in the set of reason queries and a temperature parameter configured to control a level of response diversity for the set of reason queries.

20. The method of claim 13,
wherein the set of reason queries comprises a given number (N) of input prompts, where N is greater than 1,
wherein the set of sample reasons comprises reasons generated by the first LLM in response to the respective N input prompts, and
wherein the reduced set of reasons comprises distinct reasons generated based on the reasons.

21. The method of claim 13, wherein the execution prompt comprises:
an execution set of reasons that correspond to the reduced set of reasons; and
an execution query that corresponds to the query.

22. The method of claim 13, wherein the query is submitted by a user and employing the query response comprises providing the query response to the user in response to the query, or wherein employing the query response comprises controlling a system based on the query response.

23. The method of claim 13, the reasoning engine configured to dynamically select parameters for the optimization.

24. The method of claim 13, further comprising determining of the reduced set of reasons using combinatorial optimization hardware.

25. Non-transitory computer-readable storage medium comprising program instructions stored thereon that are executable by a processor to cause the following operations for reasoning generative intelligence:
receiving a query;
determining a set of system instructions corresponding to the query;
generating, based on the query and the set of system instructions, an initial prompt comprising a set of reason queries;
submitting the initial prompt to a first large language model (LLM) to obtain a set of sample reasons corresponding to the set of reason queries;
determining, based on application of optimization to the set of sample reasons, a reduced set of reasons;
generating, based on the reduced set of reasons, an execution prompt;
submitting the execution prompt to a second LLM to obtain a query response; and
employing the query response in response to the query.
